(19) United States
(12) Patent Application Publication
(10) Pub. No.: US 2009/0022896 A1
(43) Pub. Date: Jan. 22, 2009

(54) Method for Producing a Structured Elastomer and Elastomer

(76) Inventors: Rudolf Merkel, Julich (DE); Bernd Hoffmann, Julich (DE); Claudia M. Cesa, Julich (DE); Nils Hersch, Monchengladbach (DE)

Correspondence Address: K.F. ROSS P.C., 5683 RIVERDALE AVENUE, SUITE 203 BOX 900, BRONX, NY, 10471-0900, US

(21) Appl. No.: 11/883,893

(22) PCT Filed: Feb. 1, 2006
(86) PCT No.: PCT/DE2006/000144

§ 371 Date: Jun. 26, 2008

(30) Foreign Application Priority Data
Feb. 4, 2005 (DE) 10 2005 005 121.9

(51) Int. Cl. B05D 3/10; B05D 3/00; C08L 21/00

(52) U.S. Cl. 427/336; 427/331; 525/191

(57) ABSTRACT

The invention relates to a method for producing a structured elastomer. The invention is characterised in that the elastomer is applied and hardened directly on a structured SiO₂-surface. As a result, highly-deformable, micro-structured elastomers can be produced for force sensors which are used during the characterisation of new therapeutic agents.

The invention relates to a method of producing an elastomer, and an elastomer produced in this manner.

Elastomers are polymers having rubber-elastic behavior and that may be repeatedly extended in length, resuming their original dimensions when no longer being stretched. Elastomers are wide-meshed, cross-linked high-polymer materials that do not undergo viscous flow at temperatures of use due to the linkage of the individual polymer chains at the cross linking sites.

In the production of the elastomers, in a first method step a photoresist is applied to a silicon substrate. A structure is produced on the photoresist by means of a template mask and irradiation. When positive photoresists are used, free regions result on the silicon surface after removal of the irradiated regions by use of a developer. This results in a stamp having the desired photoresist structure on the surface of the stamp. The structured surface of the photoresist is then overlain with the non-cross-linked elastomer.

For example, a mixture of vinyl-terminated siloxane as base substance of the elastomer and a methylhydrosiloxane-dimethylsiloxane copolymer as cross-cross linker may be used. Cross-cross linking of the two components is usually carried out using a platinum catalyst in an incubation step at elevated temperature. Cured polydimethylsiloxane (PDMS) is obtained on the photoresist.

The elasticity of the PDMS is regulated by the mixing ratio with respect to the cross-cross linker.

After the elastomer cures, the photoresist surface of the stamp and the elastomer are separated from one another. For this purpose the adhesive characteristics of the PDMS must be overcome. The elastomer then has an impression of the structure applied by the stamp.

Depending on use, microstructured PDMS elastomers are produced with varying elasticities. The mixing ratio of base substance to cross-cross linker according to the prior art ranges from approximately 5:1 for production of low elasticities, i.e. high Young's modulus (>1 MPa), to a maximum mixing ratio of approximately 50:1 for production of high elasticities, i.e. moderate Young's modulus (˜15 kPa).

It is disadvantageous that it has not been possible heretofore to produce microstructured PDMS elastomers with even higher elasticity. For mixing ratios of 50:1 and higher, forces that arise during separation from the stamp cause plastic deformation of the highly deformable elastomers after curing of the PDMS elastomer, resulting in destruction of the structure of the elastomer.

The method according to the prior art is also disadvantageous for the stamp itself.

At high mixing ratios above approximately 40:1 a PDMS residue remains on the photoresist surface. This surface must therefore be cleaned before it may be reused for producing microstructured surfaces. Cleaning is difficult due to the low resistance, i.e. good solubility in PDMS solvents, of photoresists. The method according to the prior art is therefore labor-intensive and costly.

Furthermore, when the elastomer is removed the fine structure of the photoresist is also frequently destroyed in addition to that of the elastomer.

The object of the invention is to provide a reusable stamp and a method of structuring elastomers, in particular highly deformable elastomers, using this stamp.

The object is achieved by a method according to the main claim and equivalent claim, and by an elastomer according to the invention. Advantageous embodiments result from the claims that refer to the main claim and equivalent claim.

In the method of producing a structured elastomer on a substrate, the elastomer is applied to a structured SiO₂ surface in the form of a stamp and polymerized, i.e. cured. According to the invention, structured SiO₂ is used as a nanostamp.

The SiO₂ may be structured using a lithographic process. The dimensions depend primarily on the structuring process.

For production of the stamp, in a first step a silicon substrate is selected and oxidized to SiO₂. Up to 5 micrometers of the Si surface may be oxidized to SiO₂. A photoresist is then applied to the SiO₂ and structured lithographically, for example. Free regions in the photoresist are thus produced that extend downward to the SiO₂ surface. The structure of the photoresist is then converted to SiO₂.

Irradiation and developing steps may be used for lithographic structuring of the photoresist. The structure is then converted from the photoresist to SiO₂ by means of reactive ion etching, for example. Last, the photoresist is removed by oxygen plasma, for example.

Within the scope of the invention it has been found that a stamp having an SiO₂ surface structured in this manner is extremely well-suited for minimizing adhesion forces that arise between the stamp surface and the cross-cross-linked PDMS elastomer.

It is advantageous that an elastomer that is applied to the SiO₂ surface and polymerized may be removed from the SiO₂ surface, even at very high base substance to cross-cross linker mixing ratios of >40:1 and in particular >50:1, without the structure of the SiO₂ stamp or the elastomer being destroyed. Polymerized elastomers having a Young's modulus of <15 kPa and even <10 kPa may be easily produced.

By use of optical lithography, for example, lateral structures ranging from several mm to approximately 400 nm may be easily produced in the photoresist and thus in the SiO₂. Even structures <50 nm may be produced by electron beam lithography. These and other methods may be used for structuring.

Structures having a depth in the SiO₂ of approximately 10 nm to 4 μm, for example, may be produced.

The SiO₂ surface of the stamp is very easy to clean. The stamp is thus reusable, resulting in a considerable cost reduction.

Structured SiO₂ is therefore very well suited for use in particular as a stamp in the production of highly deformable elastomers, as well as elastomers in general.

For production of the elastomer, a mixture of base substance and cross-cross linker is generally applied to the structure of the SiO₂ stamp and cured by use of a platinum catalyst. In the last step the elastomer is separated from the SiO₂.

For example, vinyl-terminated siloxane may be used as base substance for the elastomer, and methylhydrosiloxane-dimethylsiloxane copolymer may be used as cross-cross linker. However, when SiO₂ is used as a stamp the use is not limited to these reactants, and any other siloxane may be used. It is advantageous that siloxanes are nontoxic, in contrast to the likewise known acrylamides. Other elastomers may also be applied to SiO₂ and cured.

In a further embodiment of the invention, a mixing ratio of base substance to cross-cross linker is set to be >40:1, and in particular >50:1.

The greater the mixing ratio, the softer the elastomers become. Use of SiO₂ as the stamp surface has enabled production for the first time of highly deformable elastomers having a Young's modulus of <20 Pa and even <15 kPa without difficulty, and that after removal from the stamp retain the stamp structure without being deformed or even destroyed. It is even possible to produce elastomers having a Young's modulus of <10 Pa for extremely small structures down to 500 nanometers. Since the structuring itself has no limiting effect on the size of the structure, structures down to 50 nanometers or even smaller may be produced at the referenced Young's moduli, using the most current structuring methods.

The SiO₂ stamp may be reused immediately since the structure is retained therein.

In this manner it is possible to produce elastomers having lateral structures of several mm to approximately 500 nm with relief structures of approximately 10 nm to 4 μm and with a Young's modulus of <10 kPa.

Of course, the stamp may also be used to produce more solid elastomers.

After curing, the PDMS is obtained in the desired elasticity.

In one advantageous embodiment of the invention, the surface tension of the SiO₂ is reduced before the elastomer is separated from the SiO₂.

This may be achieved in particular by applying silanes, for example trichloroperfluorooctylsilane, to the surface of the SiO₂.

In a further particularly advantageous embodiment of the invention, isopropanol is used to reduce the surface tension.

Within the scope of the invention it has been found that the phenomenon that the entire base substance is not cross-cross-linked due to the low concentration of the copolymer is intensified at high mixing ratios of >40:1, for example.

However, an unincorporated base substance disadvantageously alters the elastic properties of the PDMS in a manner that cannot be regulated.

In addition, fairly large quantities of the base substance become incorporated in the cross-cross-linked PDMS in the form of small droplets. Besides alterations to the elasticity, these regions have an adverse effect on the transparency of the elastomer. There is little or no capability for performing microscopy on such elastomers.

Use of isopropanol also allows these non-cross-cross-linked components of the (PDMS) base substance used to be dissolved from the polymerized elastomer. In this manner the transparency of the elastomer is greatly improved in a particularly advantageous manner.

An elastomer according to the invention having high elasticity may advantageously be used as force sensors. By use of the particularly soft elastomers, new fields of application may thus be opened, for example the study of cardiac muscle cells in the course of an active substance screening.

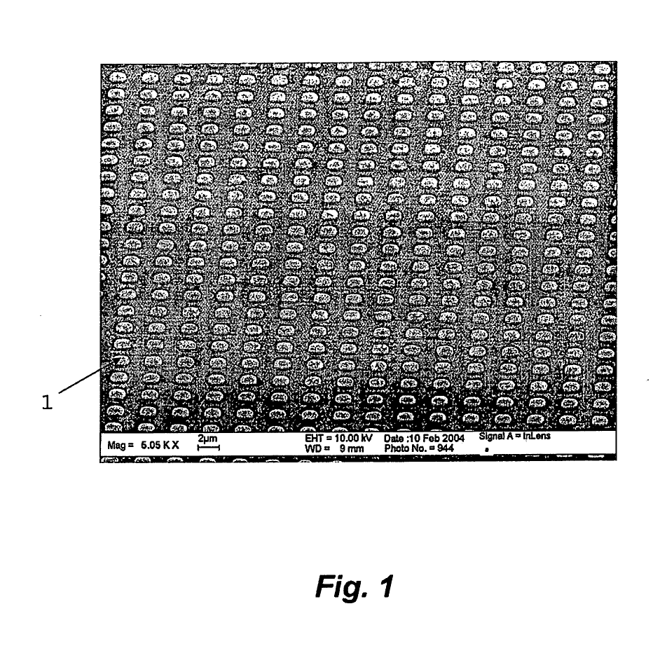

The invention is described in greater detail below with reference to one illustrated embodiment and the accompanying FIGS. 1 through 3.

For production of a reusable stamp, first a silicon substrate is oxidized. This is achieved by wet oxidation of the silicon at a temperature of 1100° C. for a period of 20 to 40 min. In this manner the silicon surface is oxidized to silicon dioxide to a depth of approximately 300 to 500 nm. A photoresist is then applied to the silicon-dioxide layer, and by use of a shadow mask the photoresist together with the structure of interest is irradiated (optical lithography).

After removal of the mask, the irradiated regions of the photoresist are removed (positive photoresists), and the remaining photoresist is surface cured at a temperature of 150° C. for approximately 30 min. To transfer the photoresist structure to the underlying SiO₂ layer, in a subsequent step available silicon dioxide regions are removed at a rate of approximately 45 nm per minute by reactive ion etching. This is achieved by using a mixture of trifluoromethane (CHF₃) and tetrafluoromethane (CF₄), thus transferring the structure of the photoresist to the SiO₂ surface.

This results in a structure in which the same regions are laterally removed in both the photoresist and the underlying silicon-dioxide layer. The depth of the structure in the SiO₂ depends on the type and duration of the etching process used.

To obtain stable microstructured silicon dioxide surfaces, the remaining photoresist regions are then removed by use of oxygen plasma.

Based on the resulting structures, these modifications allow the reproducible and rapid production of reusable microstructured SiO₂ stamps that may be used for producing microstructured PDMS surfaces. In this sense, the SiO₂ stamp also includes unoxidized silicon beneath the SiO₂.

For production of a highly deformable microstructured PDMS elastomer, trichloroperfluorooctylsilane is applied at base substance to cross-cross linker mixing ratios of >50:1 as a monolayer to the silicon dioxide surface by passive vapor deposition, under vacuum. The surface tension of the SiO₂ stamp is reduced as a result of the highly hydrophobic properties of trichloroperfluorooctylsilane.

In the present illustrated embodiment, the PDMS subsequently applied as a base substance together with a cross-cross linker is applied in a ratio of 55:1 to the SiO₂ surface and polymerized. As a result of the silanization the PDMS adheres with low intensity to the stamp surface, thus allowing the two materials to be subsequently separated more easily. The silane is therefore added to reduce the adhesion forces between the silicon dioxide surface and the cross-cross-linked PDMS.

A structured SiO₂ surface is produced, depending on the lithographic method (FIG. 1). Each circular prominence 1 has a diameter of 1.7 μm and a height of 300 nm. In the present example the distance between two prominences 1 is 1.6 μm.

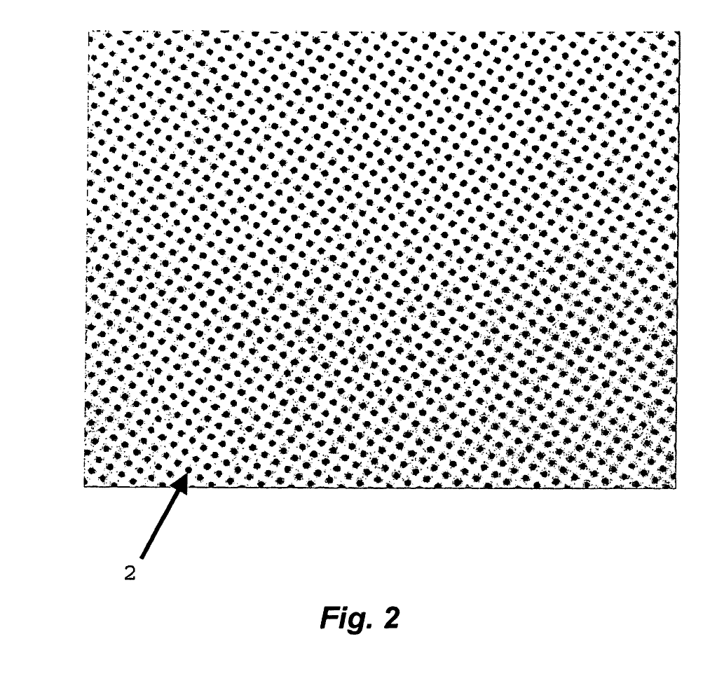

Transfer of the structure from the stamp results in a highly elastic microstructured PDMS elastomer (FIG. 2) in which each prominence on the SiO₂ stamp produces an indentation of the same dimensions. The distance from one indentation center point of the microstructure in the elastomer to the next corresponds to 3.3 μm. The indentations are visible as dark points in FIG. 2. The elastomer has a Young's modulus of approximately 10 kPa.

Isopropanol is used as solvent in the separation of the stamp and the polymerized PDMS. The isopropanol is used as solvent for unpolymerized PDMS, and at the same time reduces the surface tension of the PDMS and SiO₂ as well as the adhesiveness of the PDMS. For this purpose, isopropanol is introduced into the space between the silicon dioxide and the polymerized PDMS.

Since PDMS mixing ratios above 40:1 together with average to high elasticity result in incomplete cross linking of the vinyl-terminated siloxane used, uncrosslinked siloxane must be removed after the elastomer cures. Isopropanol is also used for this purpose. The isopropanol diffuses into the polymerized PDMS regions and dissolves unpolymerized components from the network. For PDMS films having a thickness of 100 μm, this process is terminated after an incubation time of 10 h. Depending on the mixing ratio, the treatment results in a volume reduction of approximately 10 to 15% in addition to fully transparent PDMS elastomer layers that are then available for further experiments, in particular for microscopy applications.

The invention is not limited hereto. The elastomer produced in this manner may be used as highly sensitive force sensors.

Forces from adhering or migrating cells, for example, may be analyzed in this manner. Development of such sensors is important, for example for the analysis of cell adhesion, cancer cell research, and analysis of cardiac muscle therapeutic agents.

Heretofore, effects of cardiac muscle therapeutic agents on cardiac muscle cells have primarily been investigated in animal tests. Various concentrations of the particular medication are administered to the animals that are then tested for the functioning of the therapeutic agents as well as side effects. These tests are combined with pharmaceutical analyses of isolated embryonic cardiac muscle cells of rats or chickens. For this purpose, after isolation the cells are applied confluently, i.e. so densely that cells on hard surfaces (Petri dishes) are in contact with one another. Since embryonic cardiac muscle cells are also able to contract via chemical and electrical signal transmission, even in Petri dishes, the effect of heart medications on these cells is analyzed at the tissue level.

It has not been possible heretofore to study the effect of a medication at the individual cell level. This shortcoming also applies to the analysis of heartbeat amplitude, heart rate, and the mechanical force generated by contracting cardiac muscle cells, although the aim is to manipulate such parameters by use of medications that would be of great importance for pharmaceutical safety. On account of this difficulty, although medications frequently increase the heart rate, for example, as intended, they still do not result in the desired increase in the quantity of blood transported. Mentioned by way of example is ventricular fibrillation (ventricular tachyarrhythmia), in which a very high heart rate is coupled with a very low transport rate. This has revealed numerous side effects that previously could not be identified. Analyses of isolated myocytes according to the prior art have only very limited use, since the three most important parameters, namely, the heart rate, heartbeat amplitude, and the mechanical force effects, act via the cardiac therapeutic agent in the resting state or per heartbeat. In addition, the results have heretofore been adversely affected by adhesion to hard surfaces such as plastic or glass.

The sensors and elastomers according to the invention are proposed for solving this problem. The sensitivity of the elastomer surface is much lower than that required for the mechanical force measurement of myocytes. The elastomer according to the invention thus represents a system that is well suited for precision analysis, also of the myocyte function during administration of therapeutic agents.

To this end, the elastomer surfaces are coated with natural specific proteins such as extracellular matrix molecules (ECMs), for example 2 μg/cm³ fibronectin. This allows adhesion of myoctyes to elastomer surfaces in exactly the same manner as for glass or plastic surfaces. For the analysis, cardiac muscle cells of rats were incubated for 24 hours on ultrasoft PDMS elastomer surfaces at a mixing ratio of 55:1 (Young's modulus: 10 kPa). Spontaneously contracting cardiac muscle cells were analyzed by videomicroscopy using phase contrast, as well as by reflection interference contrast microscopy. The deformation of the microstructure by the cell during the heartbeat as the result of administration of a pharmaceutical agent was converted to cell forces. This is possible since, for each PDMS mixing ratio used, the required material constants (Young's modulus and Poisson's ratio) may be determined by physical measurement methods. In this manner myocyte cell forces in the range of several nN may be measured.

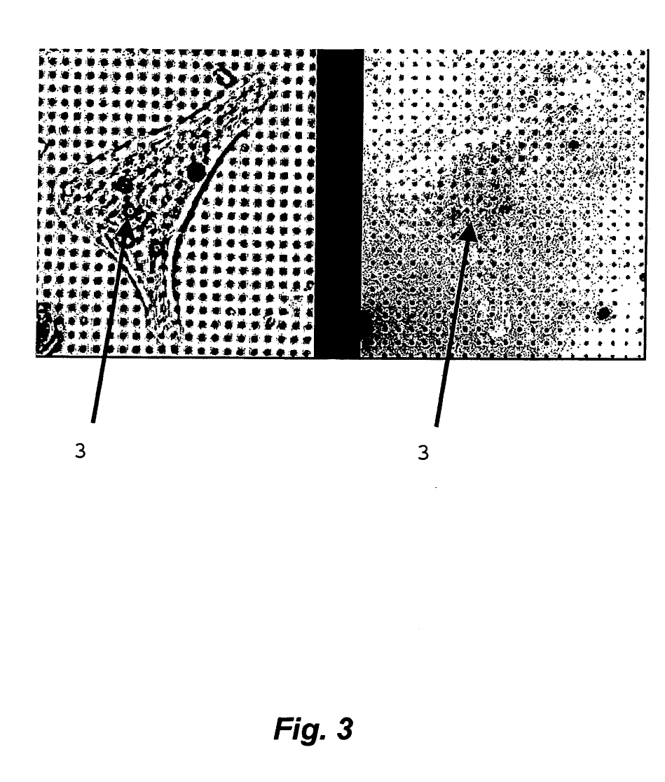

For example, this has been demonstrated for a cardiac muscle cell 3 that was incubated on the 55:1 elastomer and then analyzed by phase contrast microscopy (left side of FIG. 3) and reflection interference contrast microscopy (right side of FIG. 3). Deformations of the PDMS microstructure around or below the L-shaped cell 3 in the resting state as well as during the heartbeat were used as the basis for the above-described analysis of the cell forces. The dark inclusions in the left half of FIG. 3 represent the cell organelles.

By means of primary cell isolation of embryonic myocytes or also sinus node or atrioventricular node cells, the mechanical forces of cardiac muscle cells as well as the general function thereof may be evaluated, on individual cells as well as on cell layers, depending on the cardiac therapeutic agent tested. Thus, use of the elastomers according to the invention as sensors allows mechanical force effects of contracting myocytes to be characterized, depending on the heart medications, and compared in parallel with their heartbeat amplitude and heart rate, thereby greatly increasing the pharmaceutical safety.

Use according to the invention highly elastic, microstructured PDMS surfaces as sensors for cell forces are not limited to cardiac muscle cells, but also apply to any cell type having at the minimum adherent growth.

In the manner described above, a general, very simple method is provided for active substance screening while at the same time delivering high-quality data.

The method according to the invention has enabled production for the first time of elastomers having a Young's modulus of <40 kPa and structures <10 μm. Such elastomers are likewise very relevant for active substance screening.

1. A method of producing a structured elastomer on a substrate, the method comprising the steps of
applying the elastomer directly to a structured SiO₂ substrate and
thereafter curing the substrate and elastomer thereon.

2. The method according to one of the preceding claims wherein vinyl-terminated siloxane is the elastomer.

3. The method according to claim 1, further comprising the step of
using methylhydrosiloxane-dimethylsiloxane copolymer as cross-cross linker.

4. The method according to claim 3, further comprising the step of
employing a mixing ratio of elastomer base substance to cross-cross linker of >40:1.

5. The method according to claim 1, further comprising the step of
reducing surface tension of the SiO₂.

6. The method according to claim 1, further comprising the step of
applying silane to a surface of the SiO₂.

7. The method according to claim 1, further comprising the step of
using a solvent dissolving the elastomer from the substrate.

8. An elastomer having a Young's modulus of <40 kPa and having structures <10 μm.

9. The elastomer according to preceding claim 8, having a Young's modulus of <20 kPa and having structures <10 μm.

10. The elastomer according to claim 8, wherein the elastomer has a Young's modulus of <10 kPa.

11. The elastomer according to claim 8 wherein the structures are <50 nanometers.

12. Use of an elastomer according to claim 8 as force sensors in active substance analyses.

13. Use of isopropanol as solvent for unpolymerized elastomer components from a cross-cross-linked elastomer.
